(19) United States
(12) Patent Application Publication
(10) Pub. No.: US 2015/0310835 A1
(43) Pub. Date: Oct. 29, 2015

(54) DRIVING CIRCUIT AND DISPLAY DEVICE INCLUDING THE SAME

(71) Applicant: SAMSUNG ELECTRONICS CO., LTD., Suwon-si (KR)

(72) Inventors: SEUNG-WOO LEE, Yongin-si (KR); Chiahsin Lin, Hsinchu City (TW); Stanley Liao, Taoyuan City (TW)

(21) Appl. No.: 14/605,022

(22) Filed: Jan. 26, 2015

(30) Foreign Application Priority Data
Apr. 28, 2014 (KR) 10-2014-0050458

(51) Int. Cl. G09G 5/18; G09G 5/02

(52) U.S. Cl. CPC G09G 5/18; G09G 5/02

(57) ABSTRACT

A driving circuit is provided. The driving circuit includes a timing controller, a gamma reference voltage signal generating unit, a gamma reference voltage signal switching unit, and a data driving unit. The timing controller generates a gamma control signal, a switch control signal, a data driving unit control signal, and a data signal based on an input image data. The gamma reference voltage signal generating unit generates gamma reference voltage signals based on the gamma control signal. The gamma reference voltage signal switching unit modifies a mapping relation between the gamma reference voltage signals and switched gamma reference voltage signals based on the switch control signal output from the timing controller. The data driving unit generates data driving voltage signals corresponding to the data signal based on the data driving unit control signal and the switched gamma reference voltage signals.

### CROSS-REFERENCE TO RELATED APPLICATION

This U.S. Non-provisional application claims priority under 35 U.S.C. §119 to Korean Patent Application No. 10-2014-0050458, filed on Apr. 28, 2014, in the Korean Intellectual Property Office (KIPO), the disclosure of which is incorporated by reference herein in its entirety.

### TECHNICAL FIELD

The present inventive concept relates to a display device, and more particularly to a display device having a driving circuit driving R, G, and B data driving voltage signals.

### DISCUSSION OF THE RELATED ART

A display device may include a driving circuit that provides R, G, and B data driving voltage signals to a display panel. The R, G, and B data driving voltage signals may be generated based on R, G, and B gamma reference voltage signals and R, G, and B data received from a timing controller.

When the R, G, and B data are switched in the timing controller, the timing controller may become complex and the switching time may be increased. Thus, the driving circuit might not operate in a high-speed.

### SUMMARY

According to an exemplary embodiment of the present inventive concept, a driving circuit is provided. The driving circuit includes a timing controller, a gamma reference voltage signal generating unit, a gamma reference voltage signal switching unit, and a data driving unit. The timing controller is configured to generate a gamma control signal, a switch control signal, a data driving unit control signal, and a data signal based on an input image data, and to output the switch control signal. The gamma reference voltage signal generating unit is configured to generate a plurality of gamma reference voltage signals based on the gamma control signal. The gamma reference voltage signal switching unit is configured to modify a mapping relation between the gamma reference voltage signals and a plurality of switched gamma reference voltage signals based on the switch control signal output from the timing controller. The data driving unit is configured to generate a plurality of data driving voltage signals corresponding to the data signal based on the data driving unit control signal and the switched gamma reference voltage signals.

In an exemplary embodiment of the present inventive concept, the gamma reference voltage signals may include a plurality of R gamma reference voltage signals, a plurality of G gamma reference voltage signals, and a plurality of B gamma reference voltage signals. The switched gamma reference voltage signals may include a plurality of switched A gamma reference voltage signals, a plurality of switched B gamma reference voltage signals, and a plurality of switched C gamma reference voltage signals. The gamma reference voltage signal switching unit may include a first switch. The first switch may be configured to modify the mapping relation, based on the switch control signal, between a first R gamma reference voltage signal of the R gamma reference voltage signals, a first G gamma reference voltage signal of the G gamma reference voltage signals, and a first B gamma reference voltage signal of the B gamma reference voltage signals and a first switched A gamma reference voltage signal of the switched A gamma reference voltage signals, a first switched B gamma reference voltage signal of the switched B gamma reference voltage signals, and a first switched C gamma reference voltage signal of the switched C gamma reference voltage signals.

In an exemplary embodiment of the present inventive concept, the first switch may include a pass control signal generating unit and a pass transistor circuit. The pass control signal generating unit may be configured to generate a plurality of pass control signals based on the switch control signal. The pass control signal generating unit may output the pass control signals through a plurality of control signal output nodes, respectively. The pass transistor circuit may be configured to modify the mapping relation between the first R gamma reference voltage signal, the first G gamma reference voltage signal, and the first B gamma reference voltage signal and the first switched A gamma reference voltage signal, the first switched B gamma reference voltage signal, and the first switched C gamma reference voltage signal.

In an exemplary embodiment of the present inventive concept, the switch control signal may include a first switch control signal, a second switch control signal, and a third switch control signal. The pass control signal generating unit may include first through fifth nodes, a first switching circuit, a second switching circuit, and a third switching circuit. The first switching circuit may selectively connect a supply voltage node to the first node and the second node based on the first switch control signal. The second switching circuit may selectively connect the first node and the second node to the third node, the fourth node, and the fifth node based on the second switch signal. The third switching circuit may selectively connect the third node, the fourth node, and the fifth node to the control signal output nodes based on the third switch signal.

In an exemplary embodiment of the present inventive concept, the first switching circuit may include a first NMOS transistor and a second PMOS transistor. The first NMOS transistor may selectively connect the supply voltage node to the first node based on the first switch control signal. The second PMOS transistor may selectively connect the supply voltage node to the second node based on the first switch control signal.

In an exemplary embodiment of the present inventive concept, the second switching circuit may include a third NMOS transistor, a fourth PMOS transistor, and a fifth NMOS transistor. The third NMOS transistor may selectively connect the first node to the third node based on the second switch control signal. The fourth PMOS transistor may selectively connect the first node to the fourth node based on the second switch control signal. The fifth NMOS transistor may selectively connect the second node to the fifth node based on the second switch control signal.

In an exemplary embodiment of the present inventive concept, the control signal output nodes may include an A node, a B node, a C node, a D node, an E node, and an F node. The third switching circuit may include a sixth NMOS transistor, a seventh PMOS transistor, an eighth NMOS transistor, a ninth PMOS transistor, a tenth NMOS transistor, and an eleventh PMOS transistor. The sixth NMOS transistor may selectively connect the third node to the A node based on the third switch control signal. The seventh PMOS transistor may selectively connect the third node to the B node based on the third switch control signal. The eighth NMOS transistor may selectively connect the fourth node to the C node based on the third switch control signal. The ninth PMOS transistor may selectively connect the fourth node to the D node based on the third switch control signal. The tenth NMOS transistor may selectively connect the fifth node to the E node based on the third switch control signal. The eleventh PMOS transistor may selectively connect the fifth node to the F node based on the third switch control signal.

In an exemplary embodiment of the present inventive concept, the pass transistor circuit may include pass transistors. The pass transistors may be configured to generate the first switched A gamma reference voltage signal, the first switched B gamma reference voltage signal, and the first switched C gamma reference voltage signal by passing the first R gamma reference voltage signal, the first G gamma reference voltage signal, and the first B gamma reference voltage signal in response to the pass control signals.

In an exemplary embodiment of the present inventive concept, the gamma reference voltage signal generating unit may include an R gamma reference voltage signal generating unit, a G gamma reference voltage signal generating unit, and a B gamma reference voltage signal generating unit. The R gamma reference voltage signal generating unit may be configured to generate the R gamma reference voltage signals. The G gamma reference voltage signal generating unit may be configured to generate the G gamma reference voltage signals. The B gamma reference voltage signal generating unit may be configured to generate the B gamma reference voltage signals.

In an exemplary embodiment of the present inventive concept, the R gamma reference voltage signal generating unit may include a resistor string connected between a supply voltage node and a ground voltage node. The resistor string may include a plurality of resistors connected in series. The plurality of nodes may be located between the resistors, respectively.

In an exemplary embodiment of the present inventive concept, the R gamma reference voltage signal generating unit may further include a plurality of decoders. A first decoder of the decoder may output one of voltage signals of the plurality of the nodes as the first R gamma reference voltage signal in response to the gamma control signal.

In an exemplary embodiment of the present inventive concept, the gamma reference voltage signal generating unit may include a resistor string having a plurality of resistors connected in series between a supply voltage node and a ground voltage node. The gamma reference voltage signal generating unit may generate the R gamma reference voltage signals, the G gamma reference voltage signals, and the B gamma reference voltage signals through a plurality of nodes. The plurality of nodes may be located between the resistors, respectively, based on the gamma control signal.

In an exemplary embodiment of the present inventive concept, the gamma reference voltage signal generating unit may further include a plurality of decoders. A first decoder of the decoders may output the first R gamma reference voltage signal, the first G gamma reference voltage signal, and the first B gamma reference voltage signal. The first R gamma reference voltage signal, the first G gamma reference voltage signal, and the first B gamma reference voltage signal may be correspond to voltage signals of three nodes selected among the plurality of nodes, respectively.

According to an exemplary embodiment of the present inventive concept, a display device is provided. The display device includes a timing controller, a gamma reference voltage signal generating unit, a gamma reference voltage signal switching unit, a data driving unit, a gate driving unit, and a display panel. The timing controller is configured to generate a gamma control signal, a switch control signal, a data driving unit control signal, a gate driving unit control signal, and a data signal based on an input image data, and to output the switch control signal. The gamma reference voltage signal generating unit is configured to generate plurality of gamma reference voltage signals based on the gamma control signal. The gamma reference voltage signal switching unit is configured to modify a mapping relation between the gamma reference voltage signals and a plurality of switched gamma reference voltage signals based on the switch control signal output from the timing controller. The data driving unit is configured to generates a plurality of data driving voltage signals corresponding to the data signal based on the data driving unit control signal and the switched gamma reference voltage signals. The gate driving unit is configured to generate a plurality of gate driving voltage signals based on the gate driving unit control signal. The display panel displays an image corresponding to the input image data based on the data driving voltage signals and the gate driving voltage signals.

According to an exemplary embodiment of the present inventive concept, a driving circuit is provided. The driving circuit includes a timing controller, a gamma reference voltage signal generating unit, a gamma reference voltage signal switching unit, and a data driving unit. The timing controller is configured to generate a gamma control signal and a switch control signal based on an input image data, and to output the switch control signal. The gamma reference voltage signal generating unit is configured to generate first through third gamma reference voltage signals based on the gamma control signal. The gamma reference voltage signal switching unit is configured to modify a mapping relation between the first through third gamma reference voltage signals and first through third switched gamma reference voltage signals based on the switch control signal output from the timing controller. The gamma reference voltage signal switching unit includes a pass control signal generating unit and a pass transistor circuit. The pass control signal generating unit is configured to generate pass control signals based on the switch control signal. The pass transistor circuit is configured to generate the first through third switched gamma reference voltage signals based on the pass control signals. The pass transistor circuit includes a first transistor. A first signal corresponding to a logic OR operation result between at least two of the pass control signals is input to a gate of the first transistor. One of the first through third gamma reference voltage signals is input to a source of the first transistor. One of the first through third switched gamma reference voltage signals is input to a drain of the first transistor.

### BRIEF DESCRIPTION OF THE DRAWINGS

Exemplary embodiments of the present inventive concept will be more clearly understood from the following detailed description with reference to the accompanying drawings, in which:

FIG. 1 is a block diagram of a display device according to an exemplary embodiment of the present inventive concept;

FIG. 2 is a block diagram of a sub-circuit included in the display device of FIG. 1 according to an exemplary embodiment of the present inventive concept;

FIG. 3 is a table illustrating an operation of a first switch included in the sub-circuit of FIG. 2 according to an exemplary embodiment of the present inventive concept;

FIG. 4 is a block diagram of the first switch included in the sub-circuit of FIG. 2 according to an exemplary embodiment of the present inventive concept;

FIG. 5 is a circuit diagram of a pass control signal generating unit included in the first switch of FIG. 4 according to an exemplary embodiment of the present inventive concept;

FIG. 6 is a circuit diagram of a pass transistor circuit included in the first switch of FIG. 4 according to an exemplary embodiment of the present inventive concept;

FIGS. 7A and 7B are diagrams of equivalent circuits of the first switch of FIG. 4 according to an exemplary embodiment of the present inventive concept;

FIG. 8 is a block diagram of a gamma reference voltage signal generating unit included in the display device of FIG. 1 according to an exemplary embodiment of the present inventive concept;

FIG. 9 is a block diagram of a first digital-to-analog converter included in the sub-circuit of FIG. 2 according to an exemplary embodiment of the present inventive concept;

FIG. 10 is a timing diagram illustrating an operation of the first switch included in the sub-circuit of FIG. 2 according to an exemplary embodiment of the present inventive concept;

FIG. 11 is a block diagram of a computing system according to an exemplary embodiment of the present inventive concept; and

FIG. 12 is a block diagram of an interface used to the computing system of FIG. 11 according to an exemplary embodiment of the present inventive concept.

### DETAILED DESCRIPTION OF THE EMBODIMENTS

Hereinafter, exemplary embodiments of the present inventive concept will be described more fully with reference to the accompanying drawings, in which exemplary embodiments thereof are shown. The present inventive concept may, however, be embodied in many different forms and should not be construed as limited to the exemplary embodiments set forth herein. In the drawings, the sizes and relative sizes of layers and regions may be exaggerated for clarity. Like numerals may refer to like elements throughout the specification and drawings.

As used herein, the term “and/or” includes any and all combinations of one or more of the associated listed items.

As used herein, the singular forms “a,” “an” and “the” are intended to include the plural forms as well, unless the context clearly indicates otherwise.

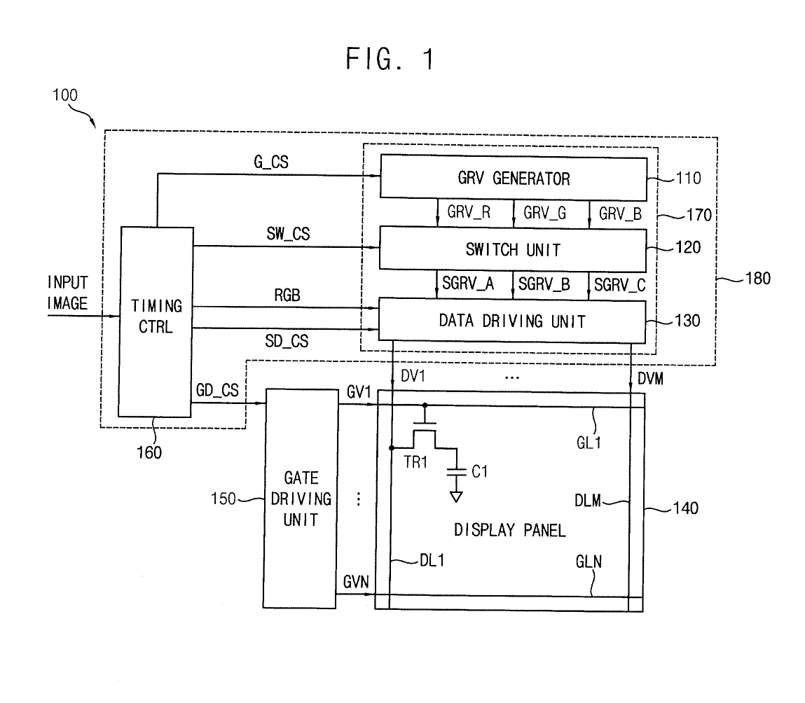

FIG. 1 is a block diagram of a display device according to an exemplary embodiment of the present inventive concept.

Referring to FIG. 1, a display device 100 includes a driving circuit 180, a gate driving unit 150, and a display panel 140. The driving circuit 180 includes a timing controller 160, a gamma reference voltage signal generating unit 110, a gamma reference voltage signal switching unit 120, and a data driving unit 130. A sub-circuit 170 includes the gamma reference voltage signal generating unit 110, the gamma reference voltage signal switching unit 120, and the data driving unit 130.

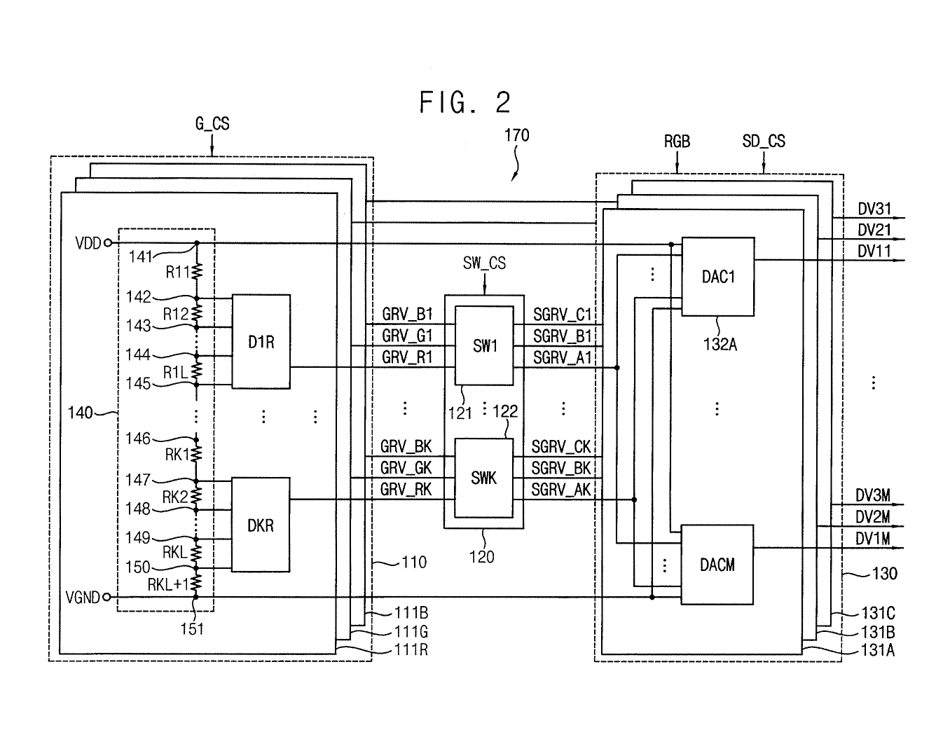

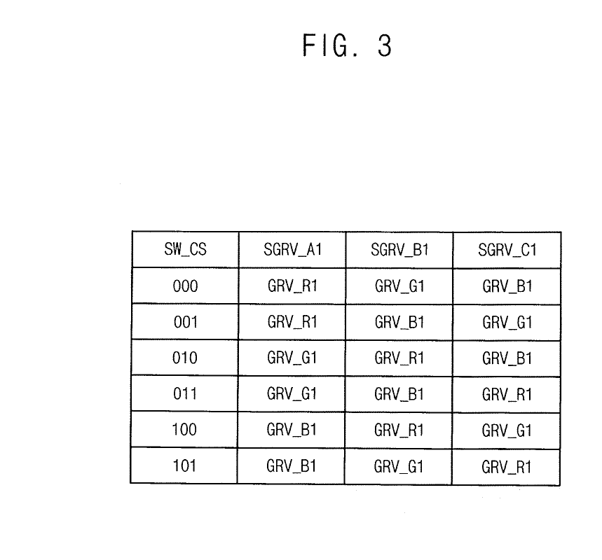

The timing controller 160 generates a gamma control signal G_CS, a switch control signal SW_CS, a data driving unit control signal SD_CS, a gate driving unit control signal GD_CS, and a data signal RGB based on an input image data INPUT IMAGE. The gamma reference voltage signal generating unit 110 generates a plurality of gamma reference voltage signals GRV_R, GRV_G, and GRV_B based on the gamma control signal G_CS. The gamma reference voltage signal switching unit 120 modifies a mapping relation between the gamma reference voltage signals GRV_R, GRV_G, and GRV_B and a plurality of switched gamma reference voltage signals SGRV_A, SGRV_B, and SGRV_C based on the switch control signal SW_CS. The data driving unit 130 generates a plurality of data driving voltage signals DV1 through DVM (M is a positive integer) corresponding to the data signal RGB based on the data driving unit control signal SD_CS and the switched gamma reference voltage signals SGRV_A, SGRV_B, and SGRV_C. The sub-circuit 170 will be described with reference to FIG. 2, and the gamma reference voltage switching unit 120 will be described with reference to FIGS. 3 through 10.

The gate driving unit 150 generates a plurality of gate driving voltage signals GV1 through GVN (N is a positive integer) based on the gate driving unit control signal GD_CS.

The display panel 140 includes first data line DL1 through (M)-th data line DLM and first gate line GL1 through (N)-th gate line GLN. The display panel 140 includes a plurality of pixel circuits which each corresponds to a combination of the first through (M)-th data lines DL1 through DLM and the first through (N)-th gate lines GL1 through GLN. The pixel circuits includes a first pixel circuit 141. The first pixel circuit 141 includes a first transistor TR1 and a first capacitor C1. A source terminal of the first transistor TR1 is electrically connected to the first data line DL1, a gate terminal of the first transistor TR1 is electrically connected to the first gate line GL1, and a drain terminal of the first transistor TR1 is electrically connected to one terminal of the first capacitor C1. Another terminal of the first capacitor C1 is electrically connected to the ground node GND. The display panel 140 displays an image corresponding to the input image data INPUT IMAGE in response to the data driving voltage signals DV1 through DVM and the gate driving voltage signals GV1 through GVN.

FIG. 2 is a block diagram of a sub-circuit included in the display device of FIG. 1 according to an exemplary embodiment of the present inventive concept.

Referring to FIG. 2, the sub-circuit 170 includes the gamma reference voltage signal generating unit 110, the gamma reference voltage signal switching unit 120, and the data driving unit 130.

The gamma reference voltage signals GRV_R, GRB_G, and GRV_B may include a plurality of R gamma reference voltage signals GRV_R1 through GRV_RK, a plurality of G gamma reference voltage signals GRV_G1 through GRV_GK, and a plurality of B gamma reference voltage signals GRV_B1 through GRV_BK. The switched gamma reference voltage signals SGRV_A, SGRV_B, and SGRV_C may include a plurality of switched A gamma reference voltage signals SGRV_A1 through SGRV_AK, a plurality of switched B gamma reference voltage signals SGRV_B1 through SGRV_BK, and a plurality of switched C gamma reference voltage signals SGRV_C1 through SGRV_CK. For example, the switched gamma reference voltage signals SGRV_A may include the plurality of switched A gamma reference voltage signals SGRV_A1 through SGRV_AK, the switched gamma reference voltage signals SGRV_B may include the plurality of switched B gamma reference voltage signals SGRV_B1 through SGRV_BK, and the switched gamma reference voltage signals SGRV_C may include the plurality of switched C gamma reference voltage signals SGRV_C1 through SGRV_CK.

The gamma reference voltage signal switching unit 120 may include first through (K)-th switches SW1 121 through SWK 122. The first switch 121 may modify the mapping relation between the first R gamma reference voltage signal GRV_R1, the first G gamma reference voltage signal GRV_G1, and the first B gamma reference voltage signal GRV_B1 and the first switched A gamma reference voltage signal SGRV_A1, the first switched B gamma reference voltage signal SGRV_B1, and the first switched C gamma reference voltage signal SGRV_C1 based on the switch control signal SW_CS.

The (K)-th switch 122 may modify the mapping relation between the (K)-th R gamma reference voltage signal GRV_RK, the (K)-th G gamma reference voltage signal GRV_GK, and the (K)-th B gamma reference voltage signal GRV_BK and the (K)-th switched A gamma reference voltage signal SGRV_AK, the (K)-th switched B gamma reference voltage signal SGRV_BK, and the (K)-th switched C gamma reference voltage signal SGRV_CK based on the switch control signal SW_CS.

The gamma reference voltage signal generating unit 110 may include an R gamma reference voltage signal generating unit 111R, a G gamma reference voltage signal generating unit 111G, and a B gamma reference voltage signal generating unit 111B. The R gamma reference voltage signal generating unit 111R may generate the R gamma reference voltage signals GRV_R1 through GRV_RK. The G gamma reference voltage signal generating unit 111G may generate the G gamma reference voltage signals GRV_G1 through GRV_GK. The B gamma reference voltage signal generating unit 111B may generate the B gamma reference voltage signals GRV_B1 through GRV_BK.

The R gamma reference voltage signal generating unit 111R may include a resistor string 140 which is connected between a supply voltage node VDD 141 and a ground voltage node VGND 151. The resistor string 140 may include a plurality of resistors R11, R12 through R1L, RK1, RK2 through RKL, and RKL+1 which are connected in series. In addition, the resistor string 140 includes a plurality of nodes 142 through 150 which each is located between the resistors R11, R12 through R1L, RK1, RK2 through RKL, and RKL+1. The R gamma reference voltage signal generating unit 111R may further include a plurality of decoders D1R through DKR. For example, the first decoder D1R may output one of a voltage signal of the first node 142, a voltage signal of the second node 143, a voltage signal of the third node 144, and a voltage signal of the fourth node 145 as the first R gamma reference voltage signal GRV_R1 in response to the gamma control signal GCS. The (K)-th decoder DKR may output one of a voltage signal of the sixth node 147, a voltage signal of the seventh node 148, a voltage signal of the eighth node 149, and a voltage signal of the ninth node 150 as the (K)-th R gamma reference voltage signal GRV_RK in response to the gamma control signal G_CS.

The G gamma reference voltage signal generating unit 111G and the B gamma reference voltage signal generating unit 111B may be understood based on substantially the same description as the R gamma reference voltage signal generating unit 111R.

The data driving unit 130 may include a first data driving unit 131A, a second data driving unit 131B, and a third data driving unit 131C. The first data driving unit 131A may generate first data driving voltage signals DV11 through DV1M. The second data driving unit 131B may generate second data driving voltage signals DV21 through DV2M. The third data driving unit 131C may generate third data driving voltage signals DV31 through DV3M.

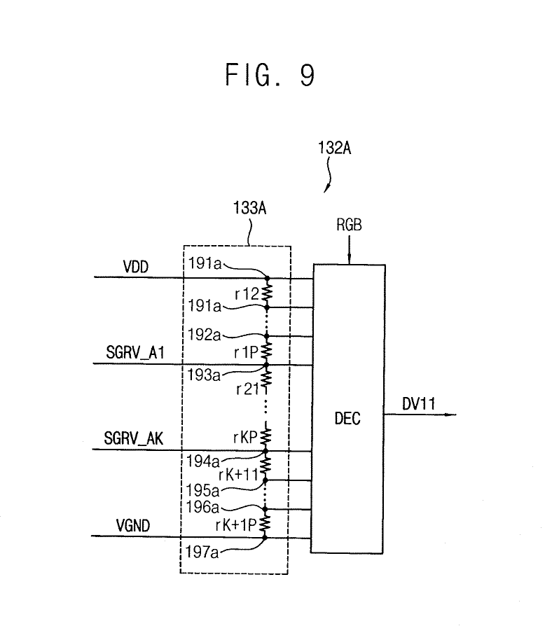

The first data driving unit 131A may include first through (M)-th digital-to-analog converters DAC1 132A through DACM. The first digital-to-analog converter 132A may generate the (1, 1)-th data driving voltage signal DV11 corresponding to the data signal RGB based on the switched A gamma reference voltage signals SGRV_A1 through SGRV_AK. The (M)-th digital-to-analog converter 133A may generate the (1, M)-th data driving voltage signal DV1M corresponding to the data signal RGB based on the switched A gamma reference voltage signals SGRV_A1 through SGRV_AK. The first digital-to-analog converter 132A will be described with reference to FIG. 9.

The second data driving unit 131B and the third data driving unit 131C may be understood based on substantially the same description as the first data driving unit 131A. Although, the gamma reference voltage signal generating unit 110 and the data driving unit 130 are described with reference to FIG. 2 in an exemplary embodiment of the present inventive concept, the present inventive concept is not limited thereto. For example, the gamma reference voltage signal generating unit 110 and the data driving unit 130 may be embodied in different forms from those described with reference to FIG. 2.

FIG. 3 is a table illustrating an operation of a first switch included in the sub-circuit of FIG. 2 according to an exemplary embodiment of the present inventive concept.

Referring to FIG. 3, when the switch control signal SW_CS has “000”, the first switch 121 outputs the first R gamma reference voltage signal GRV_R1 as the first switched A gamma reference voltage signal SGRV_A1, outputs the first G gamma reference voltage signal GRV_G1 as the first switched B gamma reference voltage signal SGRV_B1, and outputs the first B gamma reference voltage signal GRV_B1 as the first switched C gamma reference voltage signal SGRV_C1.

When the switch control signal SW_CS has “001”, the first switch 121 outputs the first R gamma reference voltage signal GRV_R1 as the first switched A gamma reference voltage signal SGRV_A1, outputs the first B gamma reference voltage signal GRV_B1 as the first switched B gamma reference voltage signal SGRV_B1, and outputs the first G gamma reference voltage signal GRV_G1 as the first switched C gamma reference voltage signal SGRV_C1.

When the switch control signal SW_CS has “010”, the first switch 121 outputs the first G gamma reference voltage signal GRV_G1 as the first switched A gamma reference voltage signal SGRV_A1, outputs the first R gamma reference voltage signal GRV_R1 as the first switched B gamma reference voltage signal SGRV_B1, and outputs the first B gamma reference voltage signal GRV_B1 as the first switched C gamma reference voltage signal SGRV_C1.

When the switch control signal SW_CS has “011”, the first switch 121 outputs the first G gamma reference voltage signal GRV_G1 as the first switched A gamma reference voltage signal SGRV_A1, outputs the first B gamma reference voltage signal GRV_B1 as the first switched B gamma reference voltage signal SGRV_B1, and outputs the first R gamma reference voltage signal GRV_R1 as the first switched C gamma reference voltage signal SGRV_C1.

When the switch control signal SW_CS has “100”, the first switch 121 outputs the first B gamma reference voltage signal GRV_B1 as the first switched A gamma reference voltage signal SGRV_A1, outputs the first R gamma reference voltage signal GRV_R1 as the first switched B gamma reference voltage signal SGRV_B1, and outputs the first G gamma reference voltage signal GRV_G1 as the first switched C gamma reference voltage signal SGRV_C1.

When the switch control signal SW_CS has “101”, the first switch 121 outputs the first B gamma reference voltage signal GRV_B1 as the first switched A gamma reference voltage signal SGRV_A1, outputs the first G gamma reference voltage signal GRV_G1 as the first switched B gamma reference voltage signal SGRV_B1, and outputs the first R gamma reference voltage signal GRV_R1 as the first switched C gamma reference voltage signal SGRV_C1.

The operation of the first switch 121 according to an exemplary embodiment of the present inventive concept is not limited to the table of FIG. 3. For example, the first switch 121 may be embodied by another method which is different from the table.

Operations of the other switches included in the gamma reference voltage signal switching unit 120 included in the sub-circuit 170 of FIG. 2 may be understood based on substantially the same description as the first switch 121.

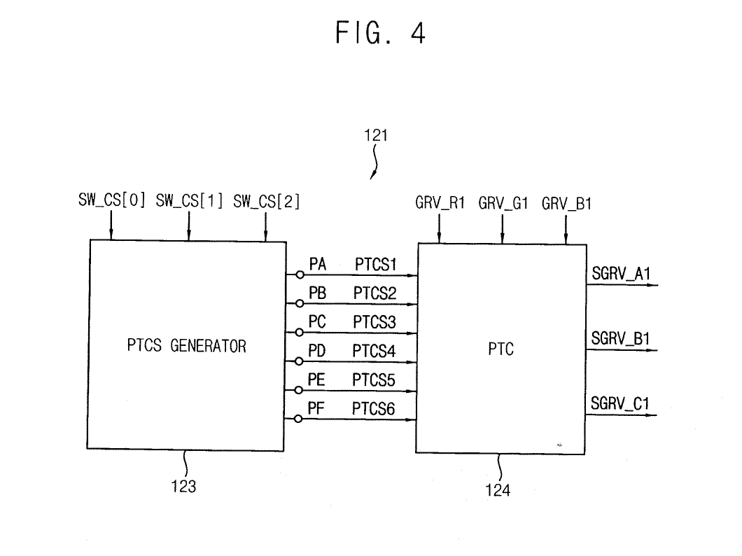

FIG. 4 is a block diagram of the first switch included in the sub-circuit of FIG. 2 according to an exemplary embodiment of the present inventive concept.

Referring to FIG. 4, the switch control signal SW_CS includes a first switch control signal SW_CS[0], a second switch control signal SW_CS[1], and a third switch control signal SW_CS[2]. The first switch 121 may include a pass control signal generating unit 123 and a pass transistor circuit 124. The pass control signal generating unit 123 may generate a plurality of pass control signals PTCS1 through PTCS6 based on the first switch control signal SW_CS[0], the second switch control signal SW_CS[1], and the third control signal SW_CS[2]. The pass control signal generating unit 123 may output the pass control signals PTCS1 through PTCS6 through a plurality of control signal output nodes PA through PF, respectively. The pass transistor circuit 124 may modify the mapping relation between the first R gamma reference voltage signal GRV_R1, the first G gamma reference voltage signal GRV_G1, and the first B gamma reference voltage signal GRV_B1 and the first switched A gamma reference voltage signal SRGV_A1, the first switched B gamma reference voltage signal SRGV_B1, and the first switched C gamma reference voltage signal SRGV_C1 based on the pass control signals PA through PF.

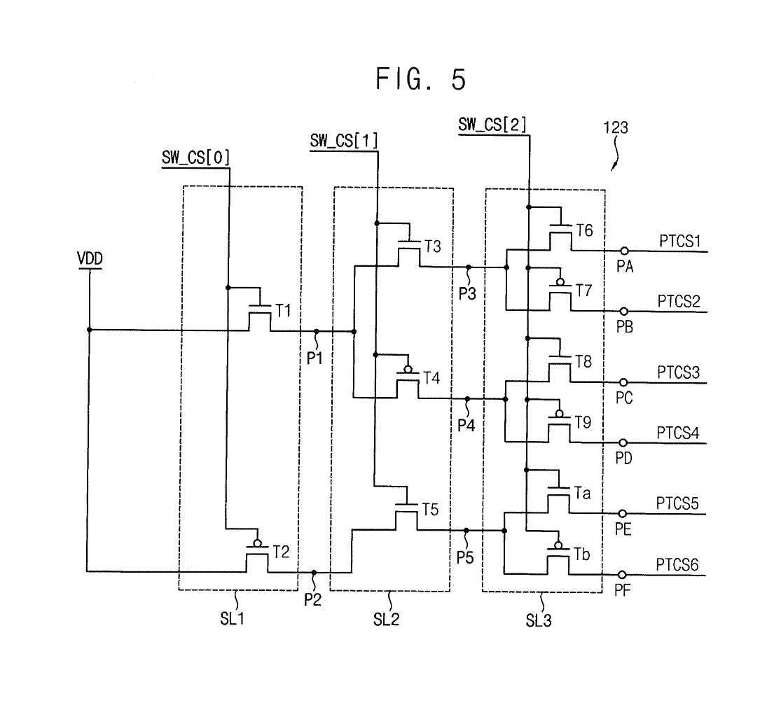

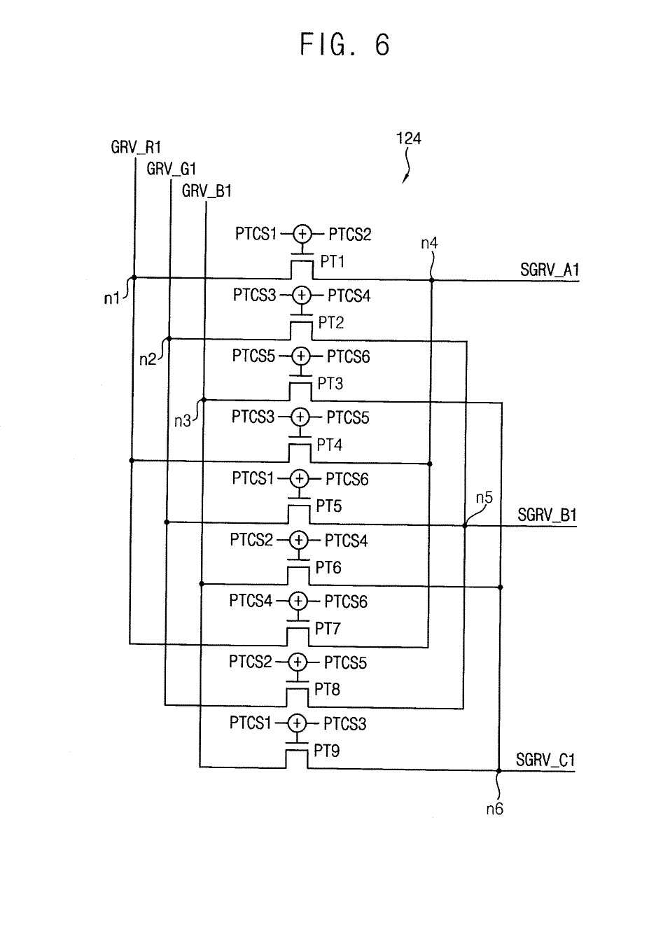

The pass control signal generating unit 123 will be described with reference to FIG. 5, and the pass transistor circuit 124 will be described with reference to FIG. 6.

The first switch 121 is illustrated in FIG. 4 in an exemplary embodiment of the present inventive concept. However, the present inventive concept is not limited thereto. For example, the first switch 121 may be embodied in different forms from that illustrated in FIG. 4.

FIG. 5 is a circuit diagram of a pass control signal generating unit included in the first switch of FIG. 4 according to an exemplary embodiment of the present inventive concept.

Referring to FIG. 5, the pass control signal generating unit 123 may include a first switching circuit SL1, a second switching circuit SL2, and a third switching circuit SL3. The first switching circuit SL1 may selectively connect a supply voltage node VDD to a first node P1 and a second node P2 in response to the first switch control signal SW_CS [0]. The second switching circuit SL2 may selectively connect the first node P1 and the second node P2 to a third node P3, a fourth node P4, and a fifth node P5 in response to the second switch signal SW_CS[1]. The third switching circuit SL3 may selectively connect the third node P3, the fourth node P4, and the fifth node P5 to the control signal output nodes PA through PF in response to the third switch signal SW_CS[2].

The first switching circuit SL1 may include a first NMOS transistor T1 and a second PMOS transistor T2. The first NMOS transistor may connect the supply voltage node VDD to the first node P1 in response to the first switch control signal SW_CS[0]. The first switch control signal SW_CS[0] may be provided to a gate terminal of the first NMOS transistor T1, a source terminal of the first NMOS transistor T1 may be electrically connected to the supply voltage node VDD, and a drain terminal of the first NMOS transistor T1 may be electrically connected to the first node P1. The second PMOS transistor may connect the supply voltage node VDD to the second node P2 in response to the first switch control signal SW_CS[0]. The first switch control signal SW_CS[0] may be provided to a gate terminal of the second PMOS transistor T2, a source terminal of the second PMOS transistor T2 may be electrically connected to the supply voltage node VDD, and a drain terminal of the second PMOS transistor T2 may be electrically connected to the second node P2.

When the first switch control signal SW_CS[0] has a logical high value, the first NMOS transistor T1 is turned-on, the supply voltage node VDD and the first node P1 are electrically connected, the second PMOS transistor T2 is turned-off, and the supply voltage node VDD and the second node P2 are electrically disconnected. When the first switch control signal SW_CS[0] has a logical low value, the first NMOS transistor T1 is turned-off, the supply voltage node VDD and the first node P1 are electrically disconnected, the second PMOS transistor T2 is turned-on, and the supply voltage node VDD and the second node P2 are electrically connected.

The second switching circuit SL2 may include a third NMOS transistor T3, a fourth PMOS transistor T4, and a fifth NMOS transistor T5. The third NMOS transistor T3 may connect the first node P1 to the third node P3 in response to the second switch control signal SWCS[1]. The second switch control signal SW_CS[1] may be provided to a gate terminal of the third NMOS transistor T3, a source terminal of the third NMOS transistor T3 may be electrically connected to the first node P1, and a drain terminal of the third NMOS transistor T3 may be electrically connected to the third node P3. The fourth PMOS transistor T4 may connect the first node P1 to the fourth node P4 in response to the second switch control signal SWCS[1]. The second switch control signal SW_CS[1] may be provided to a gate terminal of the fourth PMOS transistor T4, a source terminal of the fourth PMOS transistor T4 may be electrically connected to the first node P1, and a drain terminal of the fourth PMOS transistor T4 may be electrically connected to the fourth node P4. The fifth NMOS transistor T5 may connect the second node P2 to the fifth node P5 in response to the second switch control signal SW_CS[1]. The second switch control signal SW_CS[1] may be provided to a gate terminal of the fifth NMOS transistor T5, a source terminal of the fifth NMOS transistor T5 may be electrically connected to the second node P2, and a drain terminal of the fifth NMOS transistor T5 may be electrically connected to the fifth node P5.

When the second switch control signal SW_CS[1] has a logical high value, the third NMOS transistor T3 is turned-on, the first node P1 and the third node P3 are electrically connected, the fifth NMOS transistor T5 is turned-on, the second node P2 and the fifth node P5 are electrically connected, the fourth PMOS transistor is turned-off, and the first node P1 and the fourth node P4 are electrically disconnected. When the second switch control signal SW_CS[1] has a logical low value, the third NMOS transistor T3 is turned-off, the first node P1 and the third node P3 are electrically disconnected, the fifth NMOS transistor T5 is turned-off, the second node P2 and the fifth node P5 are electrically disconnected, the fourth PMOS transistor is turned-on, and the first node P1 and the fourth node P4 are electrically connected.

The control signal output nodes PA through PF may correspond to an A node PA, a B node PB, a C node PC, a D node PD, an E node PE, and an F node PF, respectively. The third switching unit SL3 may include a sixth NMOS transistor T6, a seventh PMOS transistor T7, an eighth NMOS transistor T8, a ninth PMOS transistor T9, a tenth NMOS transistor Ta, and an eleventh PMOS transistor Tb. The sixth NMOS transistor T6 outputs the first pass control signal PTCS1 through the A node PA, the seventh PMOS transistor T7 outputs the second pass control signal PTCS2 through the B node PB, the eighth NMOS transistor T8 outputs the third pass control signal PTCS3 through the C node PC, the ninth PMOS transistor T9 outputs the fourth pass control signal PTCS4 through the D node PD, the tenth NMOS transistor Ta outputs the fifth pass control signal PTCS5 through the E node PE, and the eleventh PMOS transistor Tb outputs the sixth pass control signal PTCS6 through F node PF.

The sixth NMOS transistor T6 may connect the third node P3 to the A node PA in response to the third switch control signal SW_CS[2]. The third switch control signal SW_CS [2] may be provided to a gate terminal of the sixth NMOS transistor T6, a source terminal of the sixth NMOS transistor T6 may be electrically connected to the third node P3, and a drain terminal of the sixth NMOS transistor T6 may be electrically connected to the A node PA.

The seventh PMOS transistor T7 may connect the third node P3 to the B node PB in response to the third switch control signal SW_CS[2]. The third switch control signal SW_CS[2] may be provided to a gate terminal of the seventh PMOS transistor T7, a source terminal of the seventh PMOS transistor T7 may be electrically connected to the third node P3, and a drain terminal of the seventh PMOS transistor T7 may be electrically connected to the B node PB.

The eighth NMOS transistor T8 may connect the fourth node P4 to the C node PC in response to the third switch control signal SW_CS[2]. The third switch control signal SW_CS[2] may be provided to a gate terminal of the eighth NMOS transistor T8, a source terminal of the eighth NMOS transistor T8 may be electrically connected to the fourth node P4, and a drain terminal of the eighth NMOS transistor T8 may be electrically connected to the C node PC.

The ninth PMOS transistor T9 may connect the fourth node P4 to the D node PD in response to the third switch control signal SW_CS[2]. The third switch control signal SW_CS[2] may be provided to a gate terminal of the ninth PMOS transistor T9, a source terminal of the ninth PMOS transistor P9 may be electrically connected to the fourth node P4, and a drain terminal of the ninth PMOS transistor T9 may be electrically connected to the D node PD.

The tenth NMOS transistor Ta may connect the fifth node P5 to the E node PE in response to the third switch control signal SW_CS[2]. The third switch control signal SW_CS[2] may be provided to a gate terminal of the tenth NMOS transistor Ta, a source terminal of the tenth NMOS transistor Ta may be electrically connected to the fifth node P5, and a drain terminal of the tenth NMOS transistor Ta may be electrically connected to the E node PE.

The eleventh PMOS transistor Tb may connect the fifth node P5 to the F node PF in response to the third switch control signal SW_CS[2]. The third switch control signal SW_CS[2] may be provided to a gate terminal of the eleventh PMOS transistor Tb, a source terminal of the eleventh PMOS transistor Tb may be electrically connected to the fifth node P5, and a drain terminal of the eleventh PMOS transistor Tb may be electrically connected to the F node PF.

When the third switch control signal SW_CS[2] has a logical high value, the sixth NMOS transistor T6 is turned-on, the third node P3 and the A node PA are electrically connected, the eighth NMOS transistor T8 is turned-on, the fourth node P4 and the C node PC are electrically connected, the tenth NMOS transistor Ta is turned-on, the fifth node P5 and the E node PE are electrically connected, the seventh PMOS transistor T7 is turned-off, the third node P3 and the B node PB are electrically disconnected, the ninth PMOS transistor T9 is turned-off, the fourth node P4 and the D node PD are electrically disconnected, and the eleventh PMOS transistor Tb is turned-off, the fifth node P5 and the F node PF are electrically disconnected. When the third switch control signal SW_CS[2] has a logical low value, the sixth NMOS transistor T6 is turned-off, the third node P3 and the A node PA are electrically disconnected, the eighth NMOS transistor T8 is turned-off, the fourth node P4 and the C node PC are electrically disconnected, the tenth NMOS transistor Ta is turned-off, the fifth node P5 and the E node PE are electrically disconnected, the seventh PMOS transistor T7 is turned-on, the third node P3 and the B node PB are electrically connected, the ninth PMOS transistor T9 is turned-on, the fourth node P4 and the D node PD are electrically connected, and the eleventh PMOS transistor Tb is turned-on, the fifth node P5 and the F node PF are electrically connected.

FIG. 6 is a circuit diagram of a pass transistor circuit included in the first switch of FIG. 4 according to an exemplary embodiment of the present inventive concept.

Referring to FIG. 6, the pass transistor circuit 124 includes OR operators, the pass transistors PT1 through PT9, and first through sixth nodes n1 through n6. The first R gamma reference voltage signal GRV_R1 is provided to the first node n1, the first G gamma reference voltage signal GRV_G1 is provided to the second node n2, and the first B gamma reference voltage signal GRV_B1 is provided to the third node n3. The first switched A gamma reference voltage signal SGRV_A1 is outputted through the fourth node n4, the first switched B gamma reference voltage signal SGRV_B1 is outputted through the fifth node n5, and the first switched C gamma reference voltage signal SGRV_C1 is outputted through the sixth node n6. A source terminal of the first pass transistor PT1 and the first node n1 are electrically connected, a resulting signal of a logical OR operation on the first pass control signal PTCS1 and the second pass control signal PTCS2, is provided to a gate terminal of the first pass transistor PT1, and a drain terminal of the first pass transistor PT1 and the fourth node n4 are electrically connected. In addition, a source terminal of the second pass transistor PT2 and the second node n2 are electrically connected, a resulting signal of a logical OR operation on the third pass control signal PTCS3 and the fourth pass control signal PTCS4 is provided to a gate terminal of the second pass transistor PT2, and a drain terminal of the second pass transistor PT2 and the fifth node n5 are electrically connected. In addition, a source terminal of the third pass transistor PT3 and the third node n3 are electrically connected, a resulting signal of a logical OR operation on the fifth pass control signal PTCS5 and the sixth pass control signal PTCS6 is provided to a gate terminal of the third pass transistor PT3, and a drain terminal of the third pass transistor PT3 and the sixth node n6 are electrically connected. In addition, a source terminal of the fourth pass transistor PT4 and the first node n1 are electrically connected, a resulting signal of a logical OR operation on the third pass control signal PTCS3 and the fifth pass control signal PTCS5 is provided to a gate terminal of the fourth pass transistor PT4, and a drain terminal of the fourth pass transistor PT4 and the fourth node n4 are electrically connected. In addition, a source terminal of the fifth pass transistor PT5 and the second node n2 are electrically connected, a resulting signal of a logical OR operation on the first pass control signal PTCS1 and the sixth pass control signal PTCS6 is provided to a gate terminal of the fifth pass transistor PT5, and a drain terminal of the fifth pass transistor PT5 and the fifth node n5 are electrically connected. In addition, a source terminal of the sixth pass transistor PT6 and the third node n3 are electrically connected, a resulting signal of a logical OR operation on the second pass control signal PTCS2 and the fourth pass control signal PTCS4 is provided to a gate terminal of the sixth pass transistor PT6, and a drain terminal of the sixth pass transistor PT6 and the sixth node n6 are electrically connected. In addition, a source terminal of the seventh pass transistor PT7 and the first node n1 are electrically connected, a resulting signal of a logical OR operation on the fourth pass control signal PTCS4 and the sixth pass control signal PTCS6 is provided to a gate terminal of the seventh pass transistor PT7, and a drain terminal of the seventh pass transistor PT7 and the fourth node n4 are electrically connected. In addition, a source terminal of the eighth pass transistor PT8 and the second node n2 are electrically connected, a resulting signal of a logical OR operation on the second pass control signal PTCS2 and the fifth pass control signal PTCS5 is provided to a gate terminal of the eighth pass transistor PT8, and a drain terminal of the eighth pass transistor PT8 and the fifth node n5 are electrically connected. In addition, a source terminal of the ninth pass transistor PT9 and the third node n3 are electrically connected, a resulting signal of a logical OR operation on the first pass control signal PTCS1 and the third pass control signal PTCS3, is provided to a gate terminal of the ninth pass transistor PT9, and a drain terminal of the ninth pass transistor PT9 and the sixth node n6 are electrically connected.

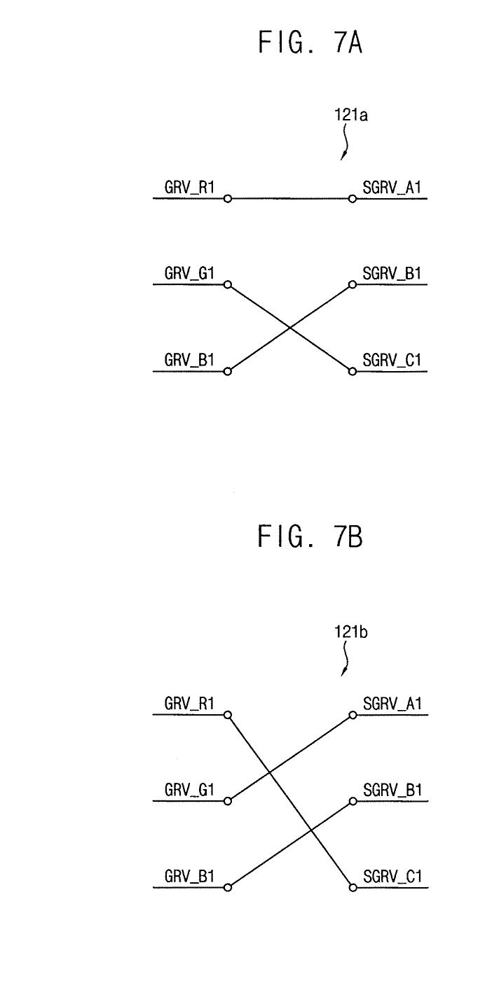

FIGS. 7A and 7B are diagrams of equivalent circuits of the first switch of FIG. 4 according to an exemplary embodiment of the present inventive concept.

Referring to FIG. 7A, a first equivalent circuit 121a corresponds to the first switch 121 of FIG. 4 when the switch control signal SW_CS has “001”. The first R gamma reference voltage signal GRVR1 is outputted as the first switched A gamma reference voltage signal SGRV_A1. The first B gamma reference voltage signal GRV_B1 is outputted as the first switched B gamma reference voltage signal SGRV_B1. The first G gamma reference voltage signal GRV_G1 is outputted as the first switched C gamma reference voltage signal SGRV_C1.

Referring to FIG. 7B, a second equivalent circuit 121b corresponds to the first switch of FIG. 4 when the switch control signal SW_CS has “011”. The first G gamma reference voltage signal GRV_G1 is outputted as the first switched A gamma reference voltage signal SGRV_A1. The first B gamma reference voltage signal GRV_B1 is outputted as the first switched B gamma reference voltage signal SGRV_B1. The first R gamma reference voltage signal GRV_R1 is outputted as the first switched C gamma reference voltage signal SGRV_C1.

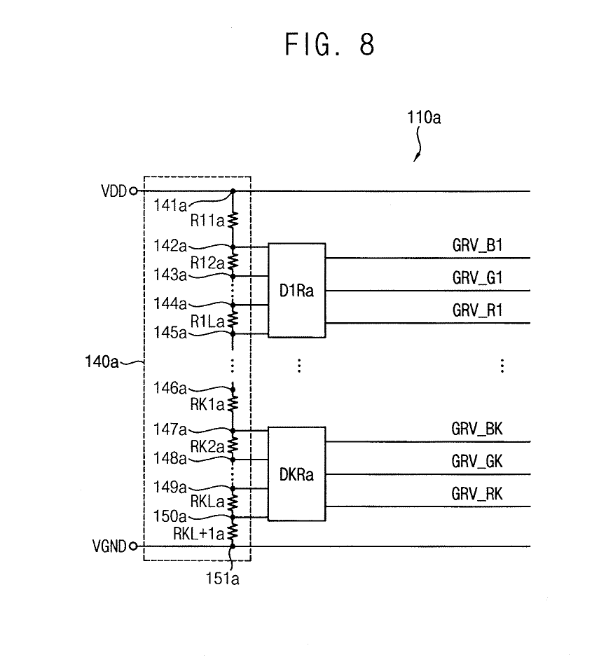

FIG. 8 is a block diagram of a gamma reference voltage signal generating unit included in the display device of FIG. 1 according to an exemplary embodiment of the present inventive concept.

Referring to FIG. 8, the gamma reference voltage signal generating unit 110a may include a resistor string 140a and first through (K)-th decoders D1Ra through DKRa. The resistor string 140a may include a plurality of resistors R11a through R1La, RK1a through RKLa, and RKL+1a and a plurality of nodes 142a through 150a of which each is located between the resistors R11a through R1La, RK1a through RKLa, and RKL+1a.

One terminal of the resistor string 140a may be electrically connected to the supply voltage node VDD, and another terminal of the resistor string 140a may be electrically connected to the ground voltage node VGND.

The first decoder D1Ra may receive a voltage signal of the node 142a, a voltage signal of the node 143a, a voltage signal of the node 144a, and a voltage signal of the node 145a. The first decoder D1Ra may output one of the received voltage signals from the nodes 142a through 145a as the first R gamma reference voltage signal GRV_R1, may output one of the received voltage signals from the nodes 142a through 145a as the first G gamma reference voltage signal GRV_G1, and may output one of the received voltage signals from the nodes 142a through 145a as the first B gamma reference voltage signal GRV_B1.

The (K)-th decoder DKRa may receive a voltage signal of the node 147a, a voltage signal of the node 148a, a voltage signal of the node 149a, and a voltage signal of the node 150a. The (K)-th decoder DKRa may output one of the received voltage signals from the nodes 147a through 150a as the (K)-th R gamma reference voltage signal GRV_RK, may output one of the received voltage signals from the nodes 147a through 150a as the (K)-th G gamma reference voltage signal GRV_GK, and may output one of the received voltage signals from the nodes 147a through 150a as the (K)-th B gamma reference voltage signal GRV_BK.

FIG. 9 is a block diagram of a first digital-to-analog converter included in the sub-circuit of FIG. 2 according to an exemplary embodiment of the present inventive concept.

Referring to FIG. 9, the first digital-to-analog converter 132A may include a resistor string 133A and a decoder DEC. The resistor string 133A may include a plurality of resistors r11 through r1P, r21 through rKP, and rK+11 through rK+1P and a plurality of nodes 190a through 197a. Each of the nodes 190a through 197a may be located between the resistors r11 through r1P, r21 through rKP, and rK+11 through rK+1P. The supply voltage signal VDD may be applied to the first node 190a, the first switched A gamma reference voltage signal SGRV_A1 may be applied to the fourth node 193a, the (K)-th switched A gamma reference voltage signal SGRV_AK may be applied to the fifth node 194a, and the ground voltage signal GND may be applied to the eighth node 197a.

In an exemplary embodiment of the present inventive concept, when the first R gamma reference voltage signal GRV_R1 through the (K)-th R gamma reference voltage signal GRV_RK are inputted as the first switched A gamma reference voltage signal SGRV_A1 through the (K)-th switched A gamma reference voltage signal SGRV_AK, respectively, the decoder DEC may output one of a voltage signal of the first node 190a, a voltage signal of the second node 191a, a voltage signal of the third node 192a, a voltage signal of the fourth node 193a, a voltage signal of the fifth node 194a, a voltage signal of the sixth node 195a, a voltage signal of the seventh node 196a, and a voltage signal of the eighth node 197a as the (1, 1)-th data driving voltage signal DV11 based on the R data signal of the data signal RGB.

In an exemplary embodiment of the present inventive concept, when the first G gamma reference voltage signal GRV_G1 through the (K)-th G gamma reference voltage signal GRV_GK are inputted as the first switched. A gamma reference voltage signal SGRV_A1 through the (K)-th switched A gamma reference voltage signal SGRV_AK, respectively, the decoder DEC may output one of a voltage signal of the first node 190a, a voltage signal of the second node 191a, a voltage signal of the third node 192a, a voltage signal of the fourth node 193a, a voltage signal of the fifth node 194a, a voltage signal of the sixth node 195a, a voltage signal of the seventh node 196a, and a voltage signal of the eighth node 197a as the (1, 1)-th data driving voltage signal DV11 based on the G data signal of the data signal RGB.

In an exemplary embodiment of the present inventive concept, when the first B gamma reference voltage signal GRV_B1 through the (K)-th B gamma reference voltage signal GRV_BK are inputted as the first switched A gamma reference voltage signal SGRV_A1 through the (K)-th switched A gamma reference voltage signal SGRV_AK, respectively, the decoder DEC may output one of a voltage signal of the first node 190a, a voltage signal of the second node 191a, a voltage signal of the third node 192a, a voltage signal of the fourth node 193a, a voltage signal of the fifth node 194a, a voltage signal of the sixth node 195a, a voltage signal of the seventh node 196a, and a voltage signal of the eighth node 197a as the (1, 1)-th data driving voltage signal DV11 based on the B data signal of the data signal RGB.

The present inventive concept is not limited thereto. The first digital-to-analog converter 132A may be embodied in different forms from that illustrated in FIG. 9. The other digital-to-analog converters of the data driving unit 130 included in the sub-circuit 170 of FIG. 2 except the first digital-to-analog converter 132A may be understood based on substantially the same description as the first digital-to-analog converter 132A.

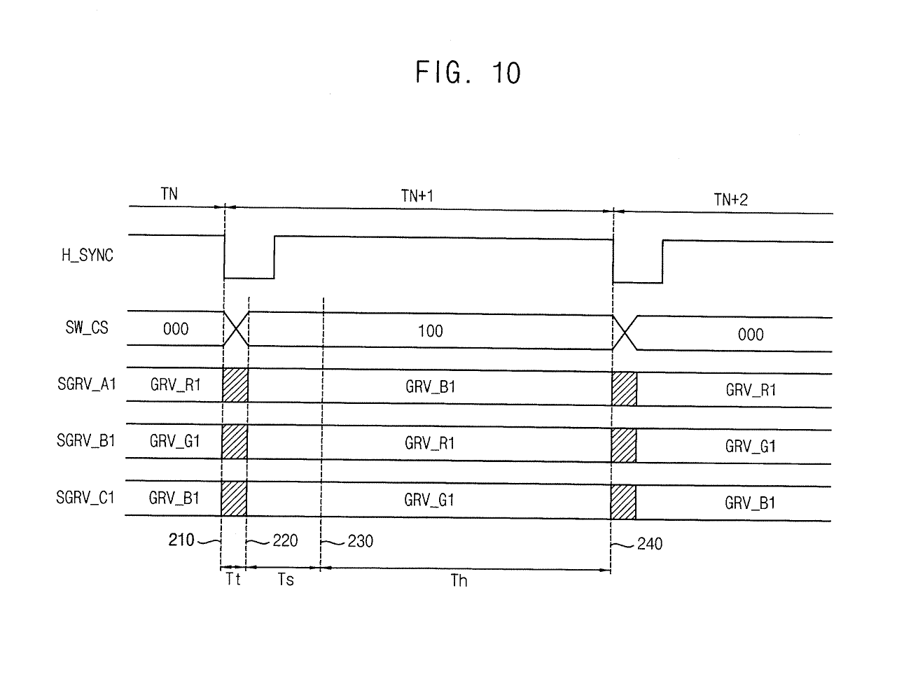

FIG. 10 is a timing diagram illustrating an operation of the first switch included in the sub-circuit of FIG. 2 according to an exemplary embodiment of the present inventive concept.

Referring to FIG. 10, an (N)-th driving time TN corresponds to a time in which pixel circuits corresponding to the (N)-th gate line of the display panel 140 of FIG. 1 are driven. The (N+1)-th driving time TN+1 corresponds to a time in which pixel circuits corresponding to the (N+1)-th gate line of the display panel 140 of FIG. 1 are driven. The (N+2)-th driving time TN+2 corresponds to a time in which pixel circuits corresponding to the (N+2)-th gate line of the display panel 140 of FIG. 1 are driven.

A level of the horizontal synchronization signal H_SYNC is changed to a logical low value at a first time point 210. Driving of the pixel circuits corresponding to (N+1)-th gate line starts at the first time point 210. A level of the switch control signal SW_CS is changed from “000” to “100” during a transition time Tt. The first switch 121 switches a value of the first switched A gamma reference voltage signal SGRV_A1 from a value of the first R gamma reference voltage signal GRV_R1 to a value of the first B gamma reference voltage signal GRV_B1 based on the switch control signal SW_CS during the transition time Tt. The first switch 121 switches a value of the first switched B gamma reference voltage signal SGRV_B1 from a value of the first G gamma reference voltage signal GRV_G1 to a value of the first R gamma reference voltage signal GRV_R1 based on the switch control signal SW_CS during the transition time Tt.

The first switch 121 switches a value of the first switched C gamma reference voltage signal SGRV_C1 from a value of the first B gamma reference voltage signal GRV_B1 to a value of the first G gamma reference voltage signal GRV_G1 based on the switch control signal SW_CS during the transition time Tt.

The first switch 121 completes the switching operations at a second time point 220. The pixel circuits corresponding to the (N+1)-th gate line outputs a stable image from the third time point 230. The settling time Ts is from the second time point 220 to the third time point 230. Driving of the pixel circuits corresponding to the (N+2)-th gate line starts at the fourth time point 240. The hold time Th is from the third time point 230 to the fourth time point 240.

As the number of gate lines included in the display panel 140 increases to display higher definition image, a driving time (e.g., TN, TN+1, and TN+2) for each gate line may become shorter. Since the display device 100 according to an exemplary embodiment of the present inventive concept may have a reduced transition time Tt, a settling time Ts and a hold time Th may be increased, and thus the display device 100 may operate in a high speed.

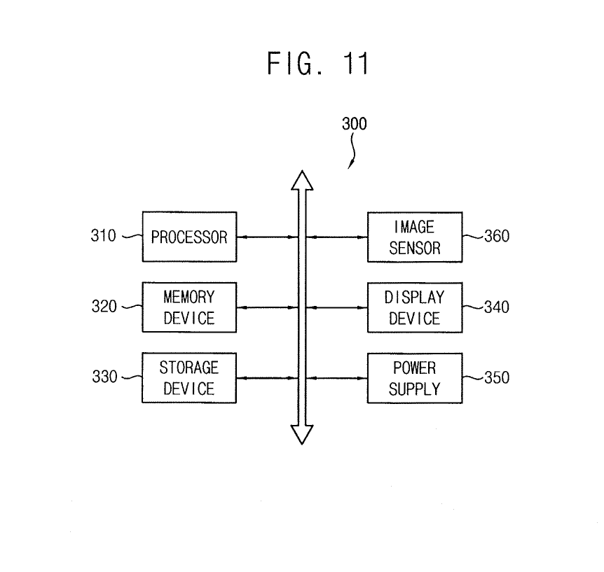

FIG. 11 is a block diagram of a computing system according to an exemplary embodiment of the present inventive concept.

Referring to FIG. 11, a computing system 300 may include a processor 310, a memory device 320, a storage device 330, a display device 340, a power supply 350, and an image sensor 360. The computing system 300 may further include ports that communicate with a video card, a sound card, a memory card, a USB device, or the like.

The processor 310 may perform various calculations or tasks. According to an exemplary embodiment of the present inventive concept, the processor 310 may be a microprocessor or a central processing unit (CPU). The processor 310 may communicate with the memory device 320, the storage device 330, and the display device 340 via an address bus, a control bus, and/or a data bus. In an exemplary embodiment of the present inventive concept, the processor 310 may be coupled to an extended bus such as a peripheral component interconnection (PCI) bus, or the like. The memory device 320 may store data for operating the computing system 300. For example, the memory device 320 may be implemented using a dynamic random access memory (DRAM) device, a mobile DRAM device, a static random access memory (SRAM) device, a phase-change random access memory (PRAM) device, a ferroelectric random access memory (FRAM) device, a resistive random access memory (RRAM) device, a magnetic random access memory (MRAM) device, and/or the like. The memory device 320 includes a data loading circuit according to an exemplary embodiment of the present inventive concept. The storage device 330 may include a solid state drive (SSD), a hard disk drive (HDD), a CD-ROM, etc. The computing system 300 may further include an input device such as a touch screen, a keyboard, a keypad, a mouse, etc., and an output device such as a printer, a display device, etc. The power supply 350 supplies voltages for operating the computing system 300.

The display device 340 may be embodied using the display device 100 of FIG. 1. The display device 340 may be understood based the descriptions made with reference to FIGS. 1 through 10.

The image sensor 360 may be connected to the processor 310 through one or more of the above buses or other communication links to communicate with the processor 310. The image sensor 360 may be integrated with the processor 310 in one chip, or the image sensor 360 and the processor 310 may be implemented as separate chips.

At least a portion of the computing system 300 may be packaged using various packaging technologies such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), wafer-level processed stack package (WSP), or the like.

The computing system 300 may be a digital camera, a mobile phone, a smart phone, a portable multimedia player (PMP), a personal digital assistant (PDA), a computer, etc.

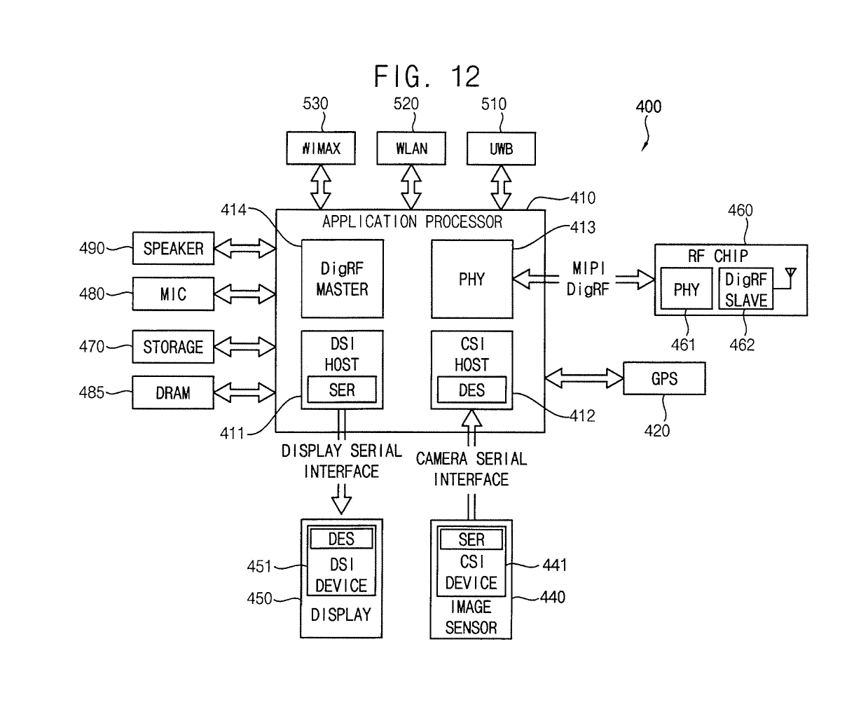

FIG. 12 is a block diagram of an interface used in the computing system of FIG. 11 according to an exemplary embodiment of the present inventive concept.

Referring to FIG. 12, a computing system 400 may be implemented using a data processing device that uses or supports a mobile industry processor interface (MIPI) interface. The computing system 400 may include an application processor 410, an image sensor 440, a display device 450, etc.

A CSI host 412 of the application processor 410 may perform a serial communication with a CSI device 441 of the image sensor 440 via a camera serial interface (CSI). In an exemplary embodiment of the present inventive concept, the CSI host 412 may include a deserializer (DES), and the CSI device 441 may include a serializer (SER). A DSI host 411 of the application processor 410 may perform a serial communication with a DSI device 451 of the display device 450 via a display serial interface (DSI).

The display device 450 may be embodied using the display device 100 of FIG. 1. The display device 450 may be understood based the descriptions made with reference to FIGS. 1 through 10.

The computing system 400 may further include a radio frequency (RF) chip 460 performing a communication with the application processor 410. A physical layer (PHY) 413 of the computing system 400 and a physical layer (PHY) 461 of the RF chip 460 may perform data communications based on a MIPI DigRF. The application processor 410 may further include a DigRF MASTER 414 that controls the data communications of the PHY 461. The RF chip 460 may further include a DigRF SLAVE 462 that is controlled by the DigRF MASTER 414.

The computing system 400 may further include a global positioning system (GPS) 420, a storage 470, a MIC 480, a DRAM device 485, and a speaker 490. In addition, the computing system 400 may perform communications using an ultra wideband (UWB) 510, an wireless local area network (WLAN) 520, a worldwide interoperability for microwave access (WIMAX) 530, etc. However, the structure and the interface of the computing system 400 are not limited thereto.

The foregoing is illustrative of exemplary embodiments of the present inventive concept and the present inventive concept should not to be construed as being limited by the embodiments described herein. Although a few exemplary embodiments have been described, it will be understood that various modifications in forms and detail may be possible without departing from the spirit and scope of the present inventive concept.

What is claimed is:

1. A driving circuit comprising:
a timing controller configured to generate a gamma control signal, a switch control signal, a data driving unit control signal, and a data signal based on an input image data, and to output the switch control signal;
a gamma reference voltage signal generating unit configured to generate a plurality of gamma reference voltage signals based on the gamma control signal;
a gamma reference voltage signal switching unit configured to modify a mapping relation between the gamma reference voltage signals and a plurality of switched gamma reference voltage signals based on the switch control signal output from the timing controller; and
a data driving unit configured to generate a plurality of data driving voltage signals corresponding to the data signal based on the data driving unit control signal and the switched gamma reference voltage signals.

2. The driving circuit of claim 1, wherein the gamma reference voltage signals includes a plurality of R gamma reference voltage signals, a plurality of G gamma reference voltage signals, and a plurality of B gamma reference voltage signals,
wherein the switched gamma reference voltage signals includes a plurality of switched A gamma reference voltage signals, a plurality of switched B gamma reference voltage signals, and a plurality of switched C gamma reference voltage signals,
wherein the gamma reference voltage signal switching unit includes a first switch, and
wherein the first switch is configured to modify the mapping relation, based on the switch control signal, between a first R gamma reference voltage signal of the R gamma reference voltage signals, a first G gamma reference voltage signal of the G gamma reference voltage signals, and a first B gamma reference voltage signal of the B gamma reference voltage signals and a first switched A gamma reference voltage signal of the switched A gamma reference voltage signals, a first switched B gamma reference voltage signal of the switched B gamma reference voltage signals, and a first switched C gamma reference voltage signal of the switched C gamma reference voltage signals.

3. The driving circuit of claim 2, wherein the first switch includes a pass control signal generating unit and a pass transistor circuit,
wherein the pass control signal generating unit is configured to generate a plurality of pass control signals based on the switch control signal, and outputs the pass control signals through a plurality of control signal output nodes, respectively, and
wherein the pass transistor circuit is configured to modify the mapping relation, based on the pass control signals, between the first R gamma reference voltage signal, the first G gamma reference voltage signal, and the first B gamma reference voltage signal and the first switched A gamma reference voltage signal, the first switched B gamma reference voltage signal, and the first switched C gamma reference voltage signal.

4. The driving circuit of claim 3, wherein the switch control signal includes a first switch control signal, a second switch control signal, and a third switch control signal,
wherein the pass control signal generating unit includes:
first through fifth nodes;
a first switching circuit configured to selectively connect a supply voltage node to the first node and the second node based on the first switch control signal;
a second switching circuit configured to selectively connect the first node and the second node to the third node, the fourth node, and the fifth node based on the second switch signal; and
a third switching circuit configured to selectively connect the third node, the fourth node, and the fifth node to the control signal output nodes based on the third switch signal.

5. The driving circuit of claim 4, wherein the first switching circuit includes:
a first NMOS transistor configured to selectively connect the supply voltage node to the first node based on the first switch control signal; and
a second PMOS transistor configured to selectively connect the supply voltage node to the second node based on the first switch control signal.

6. The driving circuit of claim 5, wherein the second switching circuit includes:
a third NMOS transistor configured to selectively connect the first node to the third node based on the second switch control signal;
a fourth PMOS transistor configured to selectively connect the first node to the fourth node based on the second switch control signal; and
a fifth NMOS transistor configured to selectively connect the second node to the fifth node based on the second switch control signal.

7. The driving circuit of claim 6, wherein the control signal output nodes include an A node, a B node, a C node, a D node, an E node, and an F node,
wherein the third switching circuit includes:
a sixth NMOS transistor configured to selectively connect the third node to the A node based on the third switch control signal;
a seventh PMOS transistor configured to selectively connect the third node to the B node based on the third switch control signal;
an eighth NMOS transistor configured to selectively connect the fourth node to the C node based on the third switch control signal;
a ninth PMOS transistor configured to selectively connect the fourth node to the D node based on the third switch control signal;
a tenth NMOS transistor configured to selectively connect the fifth node to the E node based on the third switch control signal; and
an eleventh PMOS transistor configured to selectively connect the fifth node to the F node based on the third switch control signal.

8. The driving circuit of claim 3, wherein the pass transistor circuit includes pass transistors configured to generate the first switched A gamma reference voltage signal, the first switched B gamma reference voltage signal, and the first switched C gamma reference voltage signal by passing the first R gamma reference voltage signal, the first G gamma reference voltage signal, and the first B gamma reference voltage signal in response to the pass control signals.

9. The driving circuit of claim 2, wherein the gamma reference voltage signal generating unit includes:
an R gamma reference voltage signal generating unit configured to generate the R gamma reference voltage signals;
a G gamma reference voltage signal generating unit configured to generate the G gamma reference voltage signals; and
a B gamma reference voltage signal generating unit configured to generate the B gamma reference voltage signals.

10. The driving circuit of claim 9, wherein the R gamma reference voltage signal generating unit includes a resistor string connected between a supply voltage node and a ground voltage node,
wherein the resistor string includes a plurality of resistors connected in series, and
wherein a plurality of nodes are located between the resistors, respectively.

11. The driving circuit of claim 10, wherein the R gamma reference voltage signal generating unit further includes a plurality of decoders,
wherein a first decoder of the plurality of decoders outputs one of voltage signals of the plurality of the nodes as the first R gamma reference voltage signal in response to the gamma control signal.

12. The driving circuit of claim 2, wherein the gamma reference voltage signal generating unit includes a resistor string having a plurality of resistors connected in series, the resistor string being connected between a supply voltage node and a ground voltage node,
wherein the gamma reference voltage signal generating unit generates the R gamma reference voltage signals, the G gamma reference voltage signals, and the B gamma reference voltage signals through a plurality of nodes located between the resistors respectively, based on the gamma control signal.

13. The driving circuit of claim 12, wherein the gamma reference voltage signal generating unit further includes a plurality of decoders,
wherein a first decoder of the plurality of decoders outputs the first R gamma reference voltage signal, the first G gamma reference voltage signal, and the first B gamma reference voltage signal corresponding to voltage signals of three nodes selected among the plurality of nodes, respectively.

14. A display device comprising:
a timing controller configured to generate a gamma control signal, a switch control signal, a data driving unit control signal, a gate driving unit control signal, and a data signal based on an input image data, and to output the switch control signal;
a gamma reference voltage signal generating unit configured to generate a plurality of gamma reference voltage signals based on the gamma control signal;
a gamma reference voltage signal switching unit configured to modify a mapping relation between the gamma reference voltage signals and a plurality of switched gamma reference voltage signals based on the switch control signal output from the timing controller;
a data driving unit configured to generate a plurality of data driving voltage signals corresponding to the data signal based on the data driving unit control signal and the switched gamma reference voltage signals;
a gate driving unit configured to generate a plurality of gate driving voltage signals based on the gate driving unit control signal; and
a display panel configured to display an image corresponding to the input image data based on the data driving voltage signals and the gate driving voltage signals.

15. A driving circuit, comprising:
a timing controller configured to generate a gamma control signal and a switch control signal based on an input image data, and to output the switch control signal;
a gamma reference voltage signal generating unit configured to generate first through third gamma reference voltage signals based on the gamma control; and
a gamma reference voltage signal switching unit configured to modify a mapping relation between the first through third gamma reference voltage signals and first through third switched gamma reference voltage signals based on the switch control signal output from the timing controller,
wherein the gamma reference voltage signal switching unit includes:
a pass control signal generating unit configured to generate pass control signals based on the switch control signal; and
a pass transistor circuit configured to generate the first through third switched gamma reference voltage signals based on the pass control signals,
wherein the pass transistor circuit includes a first transistor,
wherein a first signal corresponding to a logic OR operation result between at least two of the pass control signals is input to a gate of the first transistor, one of the first through third gamma reference voltage signals is input to a source of the first transistor, and one of the first through third switched gamma reference voltage signals is input to a drain of the first transistor.

16. The driving circuit of claim 15, wherein the switch control signal includes a first switch control signal, a second switch control signal, and a third switch control signal, and
wherein the pass control signal generating unit includes:
first through fifth nodes;
a first switching circuit configured to selectively connect a supply voltage node to the first node and the second node based on the first switch control signal;
a second switching circuit configured to selectively connect the first node and the second node to the third node, the fourth node, and the fifth node based on the second switch signal; and
a third switching circuit configured to selectively connect the third node, the fourth node, and the fifth node to the control signal output nodes based on the third switch signal.

17. The driving circuit of claim 16, wherein the first switching circuit includes:
a first NMOS transistor configured to selectively connect the supply voltage node to the first node based on the first switch control signal; and
a second PMOS transistor configured to selectively connect the supply voltage node to the second node based on the first switch control signal.

18. The driving circuit of claim 17, wherein the second switching circuit includes:
a third NMOS transistor configured to selectively connect the first node to the third node based on the second switch control signal;
a fourth PMOS transistor configured to selectively connect the first node to the fourth node based on the second switch control signal; and
a fifth NMOS transistor configured to selectively connect the second node to the fifth node based on the second switch control signal.

19. The driving circuit of claim 15, wherein the first through third gamma reference voltage signals correspond to an R gamma reference voltage signal, a G gamma reference voltage signal, and a B gamma reference voltage signal, respectively.

20. The driving circuit of claim 15, wherein each of the first through third gamma reference voltage signals is generated by dividing a supply voltage using a plurality of resistors connected in series.
